(19) United States
(12) Patent Application Publication
(10) Pub. No.: US 2025/0368313 A1
(43) Pub. Date: Dec. 4, 2025

(54) SYSTEM FOR MOUNTING A COMPONENT TO A VEHICLE

(71) Applicant: Gulfstream Aerospace Corporation, Savannah, GA (US)

(72) Inventors: George Sweatt, Savannah, GA (US); Rick Neilsen, Savannah, GA (US)

(73) Assignee: Gulfstream Aerospace Corporation, Savannah, GA (US)

(21) Appl. No.: 19/202,451

(22) Filed: May 8, 2025

Related U.S. Application Data
(60) Provisional application No. 63/653,073, filed on May 29, 2024.

(51) Int. Cl. B64C 1/36; H01Q 1/28

(52) U.S. Cl. CPC B64C 1/36; H01Q 1/288

(57) ABSTRACT

Disclosed here is an embodiment of a system that can be mounted to an outer panel of a vehicle, such as an aircraft. The disclosed system includes: an antenna; a carrier housing coupled to the antenna, the carrier housing having an upper section configured to receive and hold the antenna, and having a lower section opposite the upper section; and a mounting pedestal. The mounting pedestal includes: a rim having a support platform configured and arranged for coupling to the lower section of the carrier housing; a bottom section opposite the rim, the bottom section configured and arranged for coupling to the outer panel of the vehicle; and a passageway having an opening in the bottom section. The passageway extends from the bottom section toward the rim, and is configured and arranged to accommodate a structural feature of the vehicle that extends from the outer panel of the vehicle.

### CROSS-REFERENCE TO RELATED APPLICATION

This application claims the benefit of U.S. provisional patent application No. 63/653,073, filed May 29, 2024.

### TECHNICAL FIELD

Embodiments of the subject matter described herein relate generally to vehicle components. M ore particularly, embodiments of the subject matter relate to a mounting system or assembly for an aircraft component, such as a communication antenna.

### BACKGROUND

Vehicles such as aircraft, automobiles, and watercraft often include components that are mounted to or integrated with exterior panels, features, or structures. For example, automobiles may utilize exterior-mounted cameras, spoilers, antennas, sensors, and the like. Likewise, aircraft may utilize fuselage-mounted instruments, light fixtures, communication equipment, antennas, and the like. Mounting of such components can be challenging and often requires a balancing of various factors, such as weight, cost, structural integrity, decorative appearance, and aerodynamic performance.

Accordingly, it is desirable to have a mounting system for a component that is intended to be attached to or integrated with the exterior of a host vehicle. In addition, it is desirable to have a component mounting system that is robust, secure, and aerodynamic. Furthermore, other desirable features and characteristics will become apparent from the subsequent detailed description and the appended claims, taken in conjunction with the accompanying drawings and the foregoing technical field and background.

### BRIEF SUMMARY

A system for mounting a component to an outer panel of a vehicle is disclosed here. An embodiment of the system includes: a carrier housing having an upper section configured to receive and hold the component, and having a lower section opposite the upper section; and a mounting pedestal. The mounting pedestal includes: a rim having a support platform configured and arranged for coupling to the lower section of the carrier housing; a bottom section opposite the rim, the bottom section configured and arranged for coupling to the outer panel of the vehicle; and a passageway having an opening in the bottom section. The passageway extends from the bottom section toward the rim, and the passageway is configured and arranged to accommodate a structural feature of the vehicle that extends from the outer panel of the vehicle.

Another embodiment of the system includes: an antenna component; a carrier housing coupled to the antenna component, the carrier housing having an upper section configured to receive and hold the antenna component, and having a lower section opposite the upper section; and a mounting pedestal. The mounting pedestal includes: a rim having a support platform configured and arranged for coupling to the lower section of the carrier housing; a bottom section opposite the rim, the bottom section configured and arranged for coupling to the outer panel of the vehicle; and a passageway having an opening in the bottom section. The passageway extends from the bottom section toward the rim, the passageway configured and arranged to accommodate a structural feature of the vehicle that extends from the outer panel of the vehicle.

Also disclosed here is a vehicle, such as an aircraft, that includes a system for mounting a component to an outer panel of the vehicle.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a top-front perspective view of an aircraft with a component mounted thereto using a mounting system configured in accordance with certain embodiments of the invention;

FIG. 2 is a top-front perspective view that depicts a section of an aircraft fuselage with an antenna and an associated mounting system attached thereto, in accordance with certain embodiments of the invention;

FIG. 3 is a top-rear perspective view that depicts the antenna and mounting system shown in FIG. 2;

FIG. 4 is a top view that depicts the antenna and mounting system shown in FIG. 2;

FIG. 5 is a left side view that depicts the antenna and mounting system shown in FIG. 2;

FIG. 6 is a top perspective view of the antenna shown in FIG. 2;

FIG. 7 is a top perspective view of an embodiment of a carrier housing suitable for use with the mounting system shown in FIG. 2;

FIG. 8 is a bottom perspective view of the carrier housing shown in FIG. 7;

FIG. 9 is a top view of the carrier housing shown in FIG. 7;

FIG. 10 is a bottom view of the carrier housing shown in FIG. 7;

FIG. 11 is a top view of an embodiment of a retaining frame suitable for use with the mounting system shown in FIG. 2;

FIG. 12 is a top-front perspective view of an embodiment of a mounting pedestal suitable for use with the mounting system shown in FIG. 2;

FIG. 13 is a top-rear perspective view of the mounting pedestal shown in FIG. 12;

FIG. 14 is a bottom perspective view of the mounting pedestal shown in FIG. 12;

FIG. 15 is a top view of the mounting pedestal shown in FIG. 12;

FIG. 16 is a bottom view of the mounting pedestal shown in FIG. 12;

FIG. 17 is a front view of the mounting pedestal shown in FIG. 12;

FIG. 18 is a side perspective view that shows the interior side of one half of the mounting pedestal shown in FIG. 12;

FIG. 19 is a perspective view that shows an exemplary arrangement of components and features (for mounting, installation, and structural support) that reside underneath the fuselage skin of a host aircraft;

FIGS. 20-26 are schematic top views that illustrate the installation of an antenna and related mounting system configured in accordance with embodiments of the invention;

FIG. 27 is a top-front perspective view of an alternate embodiment of a component mounting system; and

FIG. 28 is an exploded perspective view of the component mounting system shown in FIG. 27.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

The following description may refer to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms referring to structures do not imply a sequence or order unless clearly indicated by the context.

A fairing for a vehicle component, and its related installation and mounting system, are disclosed herein. In accordance with certain non-limiting embodiments, the vehicle component and its related mounting system are deployed onboard an aircraft such as an airplane. However, it should be appreciated that embodiments of the disclosed subject matter can be utilized for other vehicle applications including, without limitation: trains; helicopters; automobiles; watercraft; submarines; monorails; amusement park rides; transportation systems; spacecraft; or the like. Moreover, although the exemplary application described herein relates to the mounting of an antenna component, the disclosed subject matter can be utilized in conjunction with other types of vehicle-mounted components, e.g., cameras, instruments, sensors, light fixtures, aerodynamic features, structural elements, windows, solar panels, or the like.

Certain embodiments of the disclosed subject matter relate to a system for mounting a component to an outer panel of a vehicle. The disclosed system includes an aerodynamic mounting pedestal and related assemblies for mounting an antenna component to the upper fuselage of an aircraft. In accordance with certain embodiments, the disclosed subject matter provides a solution for the installation of a flat panel satellite communication antenna on the upper fuselage skin of an aircraft. A flat panel antenna is secured and held within a carrier housing (which serves as an adapter) that resembles a picture frame, and the adapter is supported by a pedestal assembly, which may be implemented as a unitary component or a combination of multiple components that are coupled to each other or otherwise cooperate with each other in a desired configuration. Certain features and structure of the mounting system are shaped, sized, and configured to provide resistance or protection from lightning strikes and bird impacts. The mounting system can be reinforced by a system of doublers, frames, intercostals, clips, and/or other components to react and distribute all encountered stresses of the antenna and mounting elements safely to the aircraft structure.

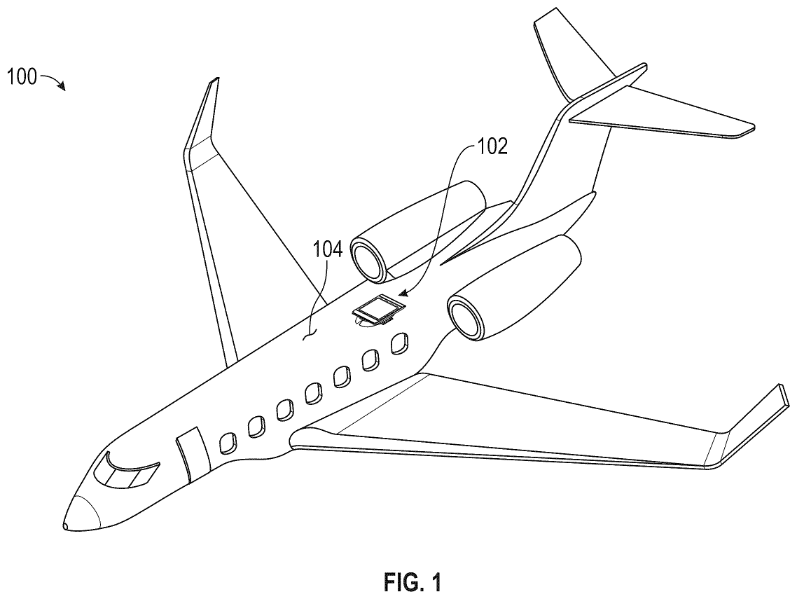

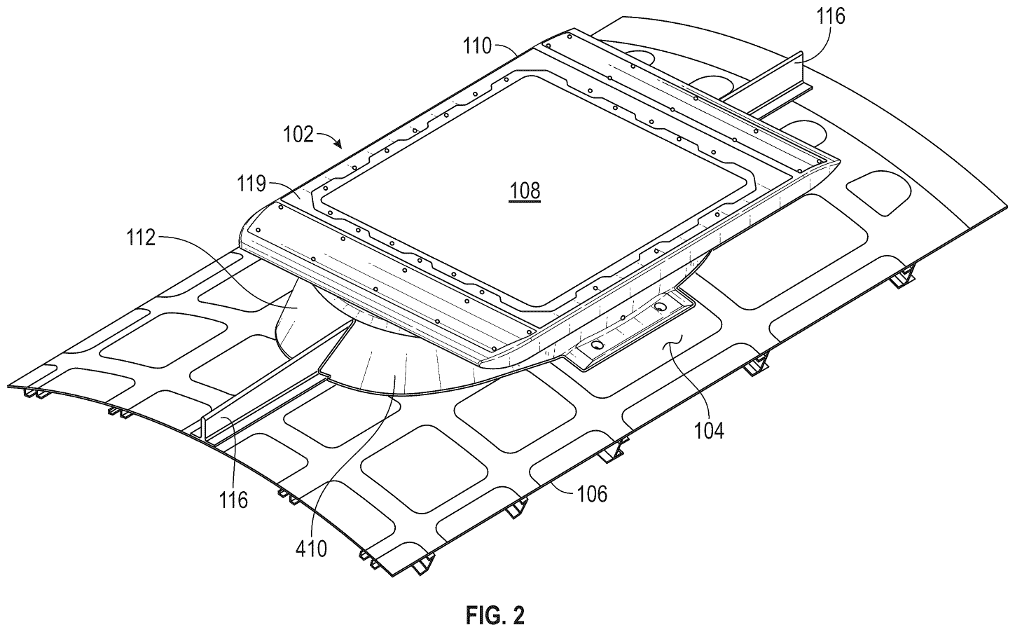

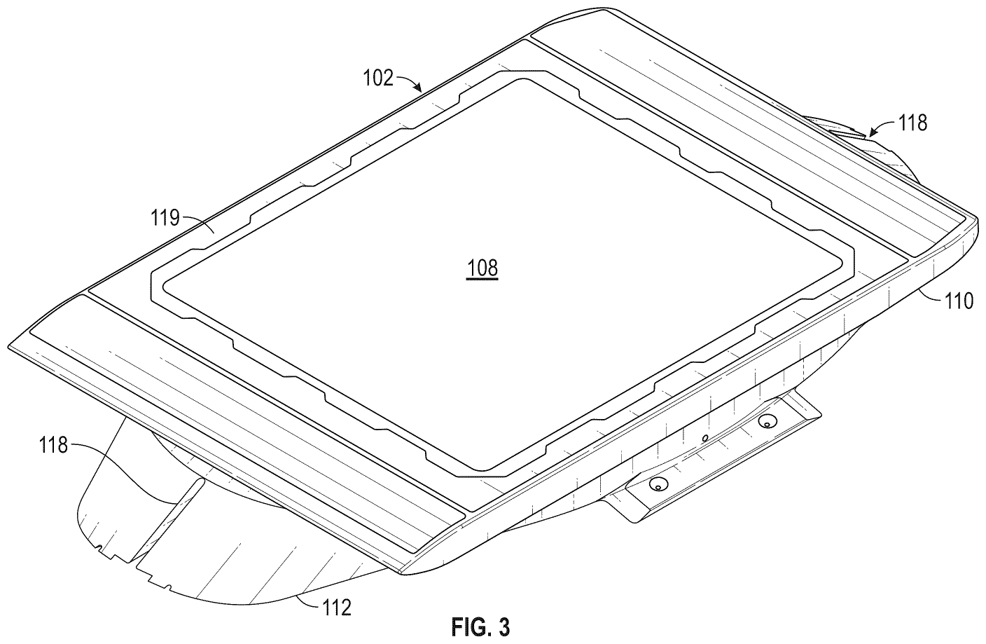

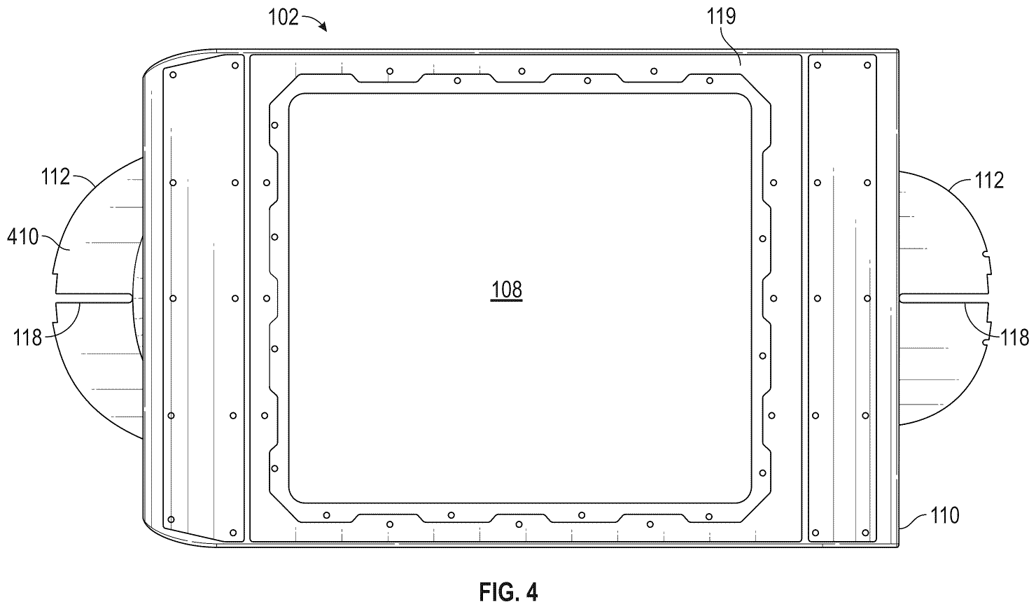

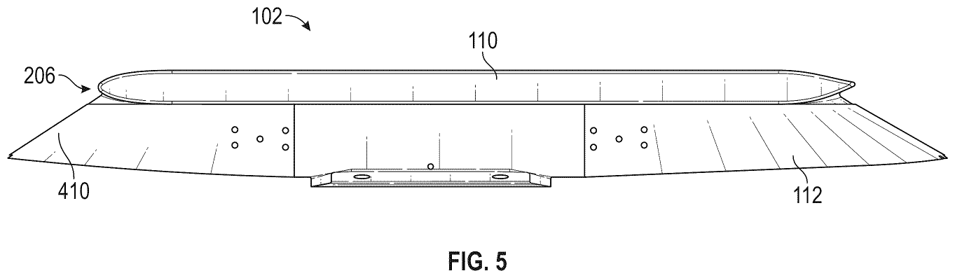

FIG. 1 is a top-front perspective view of an aircraft 100 with an exemplary embodiment of a component mounting system 102 attached to an outer panel (e.g., a fuselage skin 104 or a section thereof) of the aircraft 100. The system 102 described here includes an antenna secured within a carrier housing, which in turn is affixed to the aircraft 100 using a mounting pedestal. FIG. 2 is a top-front perspective view that depicts a section of the aircraft fuselage 106 with an antenna 108 and two primary components of the system 102 (a carrier housing 110 and a mounting pedestal 112). The exposed outer surface of the fuselage 106 corresponds to the fuselage skin 104. FIG. 3 is a top-rear perspective view that depicts the antenna 108 and the mounting system 102, FIG. 4 is a top view thereof, and FIG. 5 is a left side view thereof.

The illustrated embodiment of the mounting system 102 includes two primary components: the mounting pedestal 112, which may be a unitary one-piece component or an assembly of a plurality of physically distinct parts; and the carrier housing 110, which may be a unitary one-piece component or an assembly of a plurality of physically distinct parts. When the system 102 is deployed, the mounting pedestal 112 is coupled to the fuselage 106, the carrier housing 110 is coupled to the mounting pedestal 112, and the antenna 108 is coupled to the carrier housing 110. Electrical cables, wires, conduits, and signal paths are established between the antenna 108 and the necessary components, couplers, and/or subsystems of the host aircraft 100.

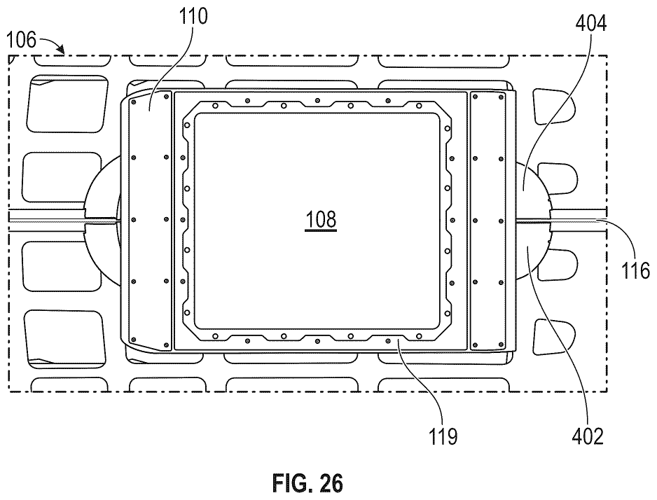

Referring to FIG. 2, the aircraft 100 includes a structural feature (e.g., a dorsal structure 116) that extends above the outer fuselage skin 104. The dorsal structure 116 is also shown in FIGS. 20-25. As explained in more detail below, the mounting pedestal 112 is designed and fabricated in an appropriate manner to accommodate the dorsal structure 116, which need not be modified, moved, or uninstalled when attaching the system 102 to the aircraft 100. For example, the mounting pedestal 112 may include or define a slot or passageway 118 for the dorsal structure 116 (see FIG. 3 and FIG. 4).

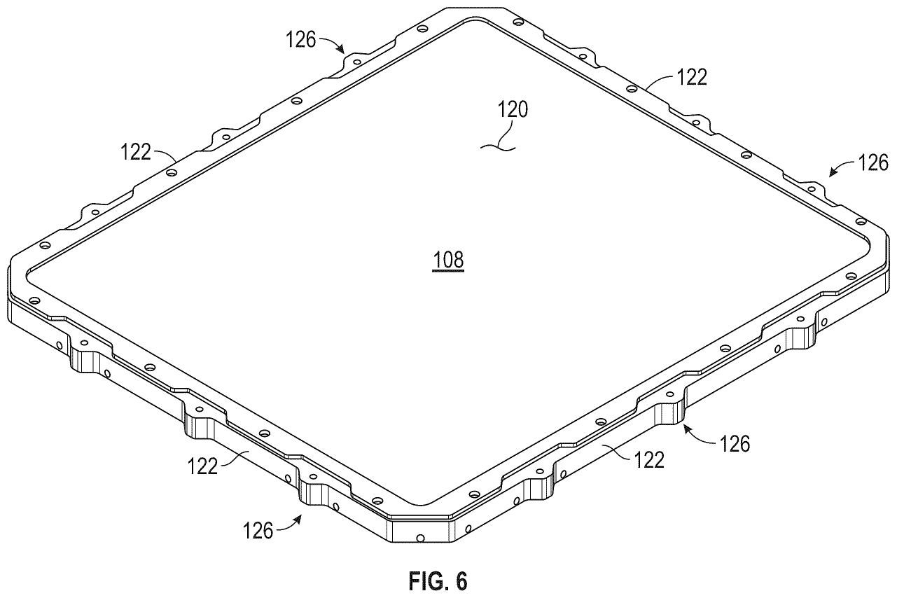

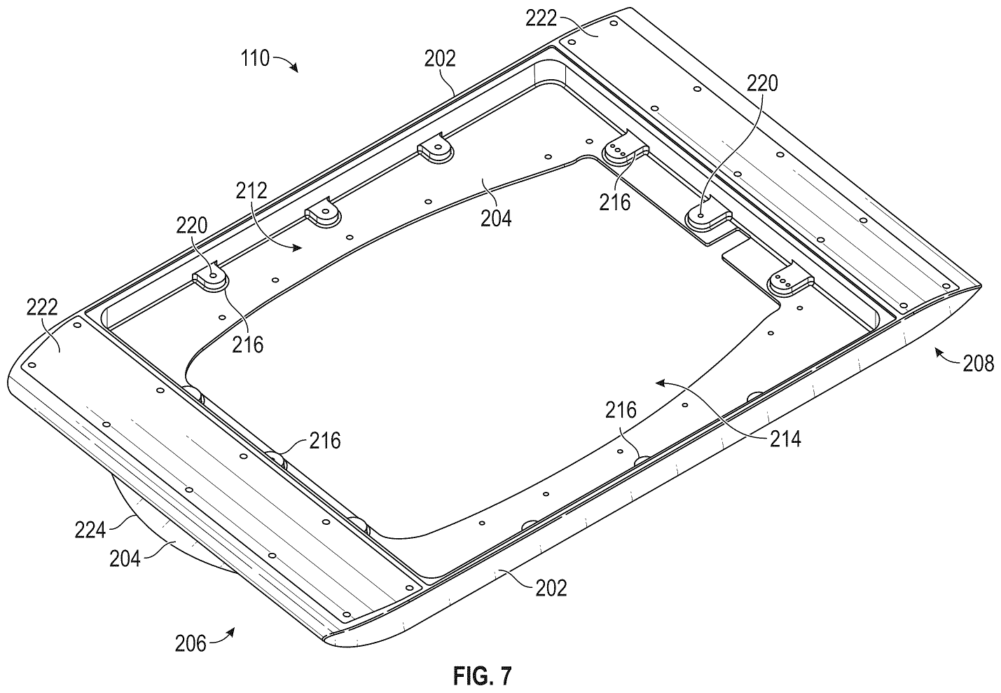

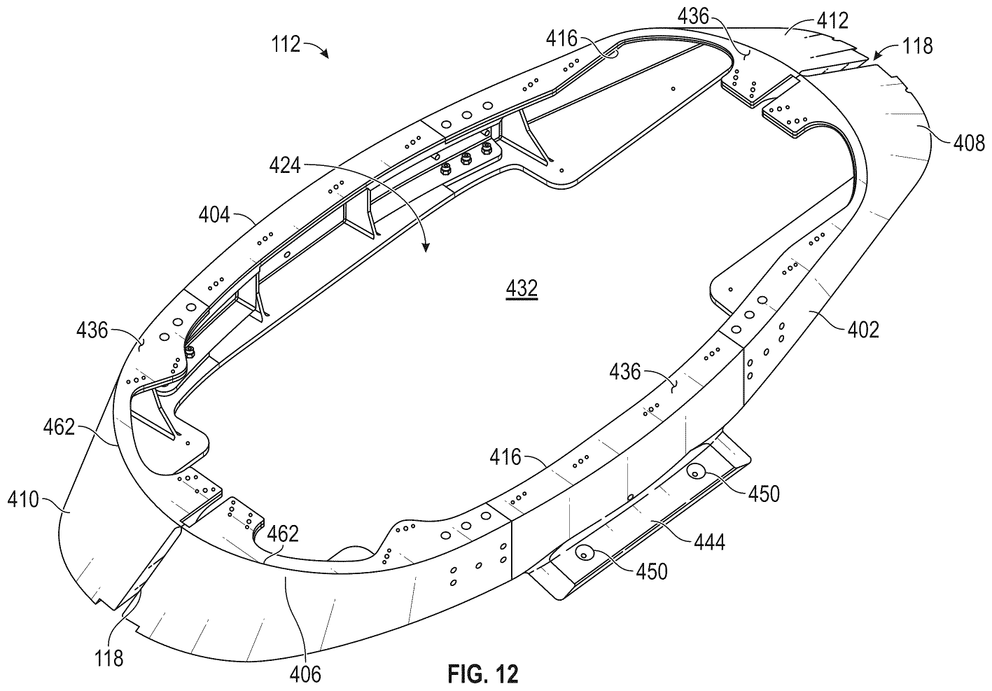

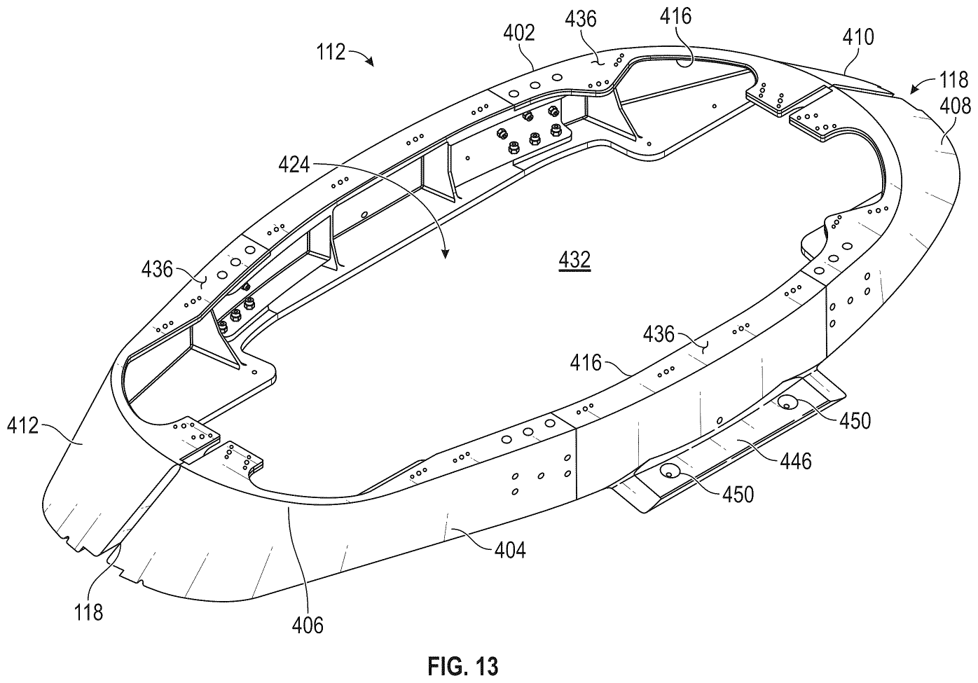

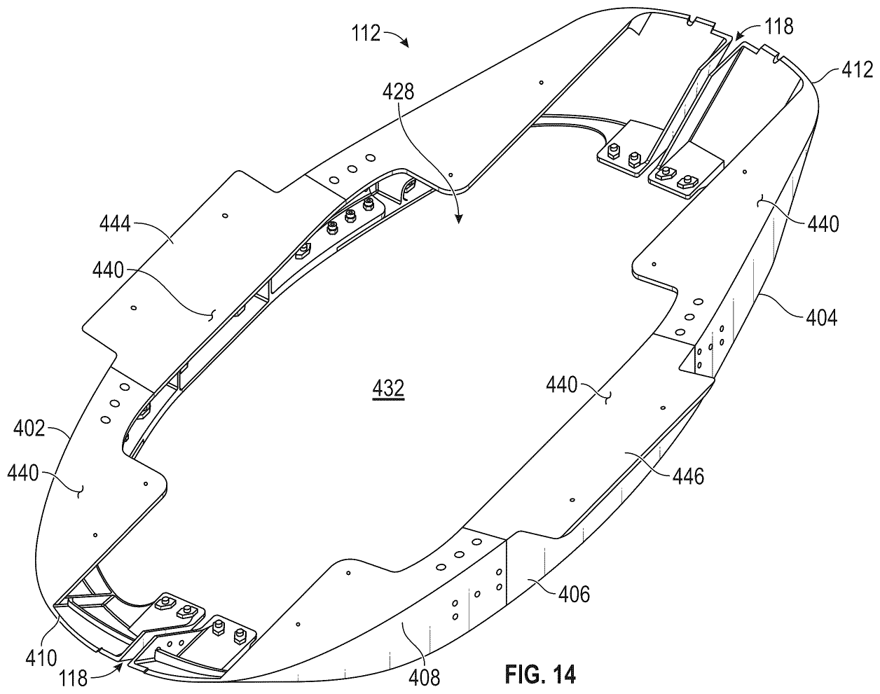

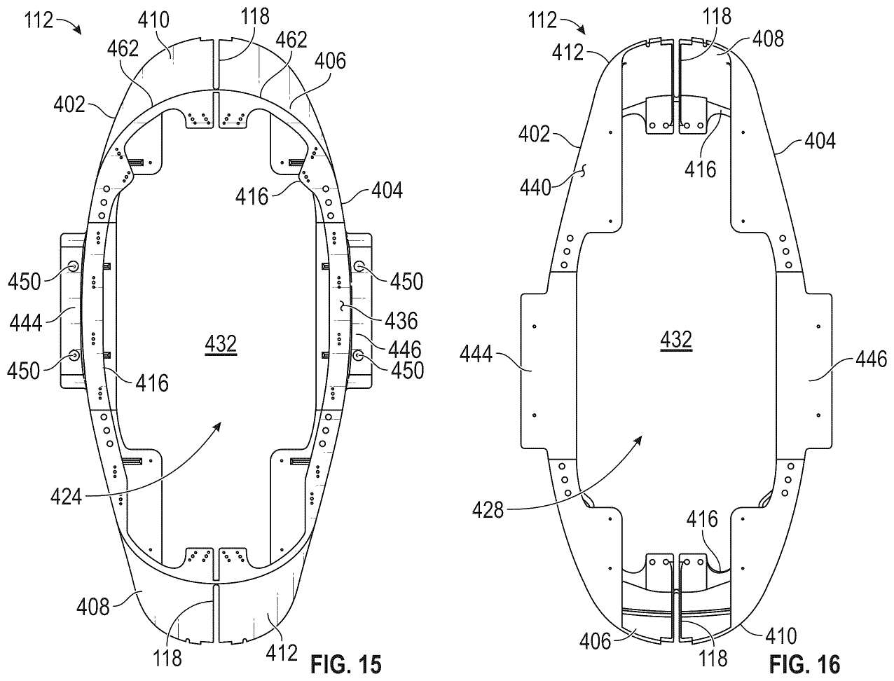

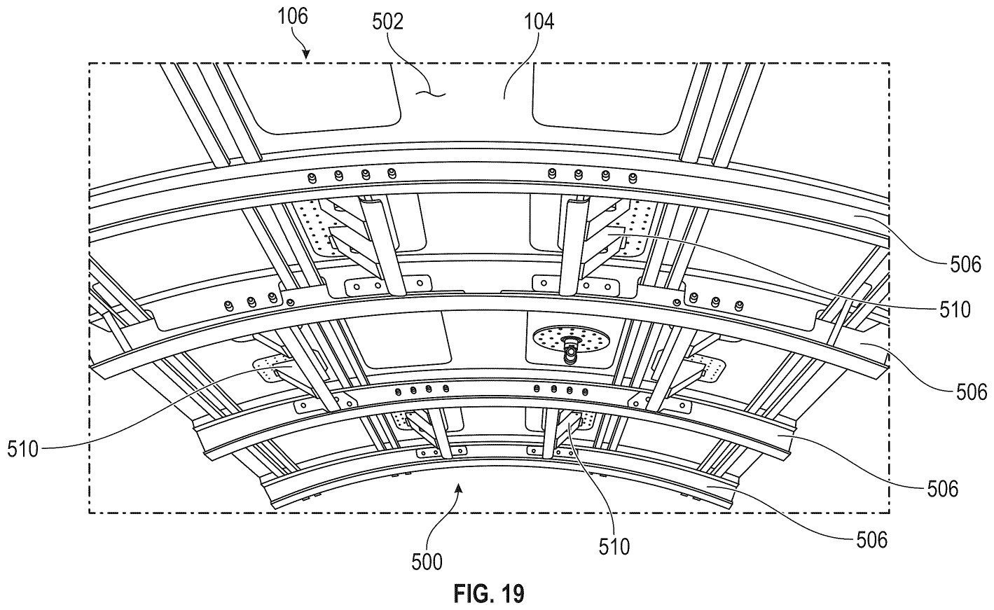

FIG. 6 is a top perspective view of an exemplary embodiment of the antenna 108; FIGS. 7-10 are different views of an exemplary embodiment of the carrier housing 110; and FIG. 11 is a top view of an embodiment of a retaining frame 119 that is suitable for use with the mounting system 102. FIGS. 12-18 are different views of an exemplary embodiment of the mounting pedestal 112.

As mentioned above, the described implementation of the antenna 108 is a flat panel satellite communication antenna having a low profile “tile” configuration. The perimeter region of the antenna 108 includes various mounting hole features, cutouts, and a particular shape that are taken into consideration. Referring to FIG. 6, the antenna 108 has a major surface 120 and a perimeter edge 122 that corresponds to a sidewall of the antenna 108. As explained in more detail below, the carrier housing 110 is shaped, sized, and configured to surround the perimeter edge 122 of the antenna 108. The carrier housing 110 is coupled to the antenna 108, and holds the antenna 108 such that the major surface 120 is exposed when the system 102 is installed on the host aircraft 100. The system 102 can be positioned in a desirable location on the fuselage skin 104 that enhances the electromagnetic performance of the antenna 108. In certain implementations, the mounting pedestal 112 can be designed and fabricated as a universal component of the system 102, whereas the carrier housing 110 can be designed, configured, and manufactured for compatibility with the particular shape, size, dimensions, and layout of the antenna 108. In this way, the same mounting pedestal 112 can be utilized (and maintained in its installed state) to mount different types of antennas or other components, as long as the carrier housing 110 can be redesigned or customized while still being compatible with the universal mounting pedestal 112.

Referring to FIG. 6, the depicted embodiment of the antenna 108 includes a plurality of mounting locations 126 distributed around the outer perimeter of the antenna 108. For this particular implementation, the antenna 108 has twelve mounting locations 126—three on each side. Each mounting location 126 includes or cooperates with a protrusion having a mounting hole formed therein. In addition, each mounting location 126 may be defined by a cutout or recess, such that a major upper surface of each mounting location 126 resides below an uppermost perimeter surface of the antenna 108. In this regard, FIG. 6 shows twelve depressions around the outer perimeter of the antenna 108, wherein the protrusions and mounting holes are co-located with the protrusions. These structural features of the antenna 108 cooperate with counterpart structural features of the carrier housing 110 and the retaining frame 119, as further described below.

Referring to FIGS. 7-10, the carrier housing 110 is suitably configured to be compatible with the particular shape, size, and dimensions of the antenna 108, and is configured to receive and hold the antenna 108 in accordance with the desired installation scheme. The carrier housing 110 is manufactured from a strong and tough material such as steel, aluminum, a composite material, plastic, or the like. The carrier housing 110 can be fabricated as a one-piece unitary component, or as an assembly of any number of constituent parts.

The illustrated embodiment of the carrier housing 110 is designed to receive and hold the antenna 108, which can be secured to compatible mounting features or structures of the carrier housing 110 using bolts, screws, fasteners, clips, or the like. The carrier housing 110 generally includes, without limitation: an upper section 202; a lower section 204 opposite the upper section 202; a forward region 206; a back region 208 opposite the forward region 206; a base region 210; a component cavity 212; an access opening 214 defined in the lower section 204; and landings 216 that are arranged for compatibility with the particular physical configuration of the antenna 108.

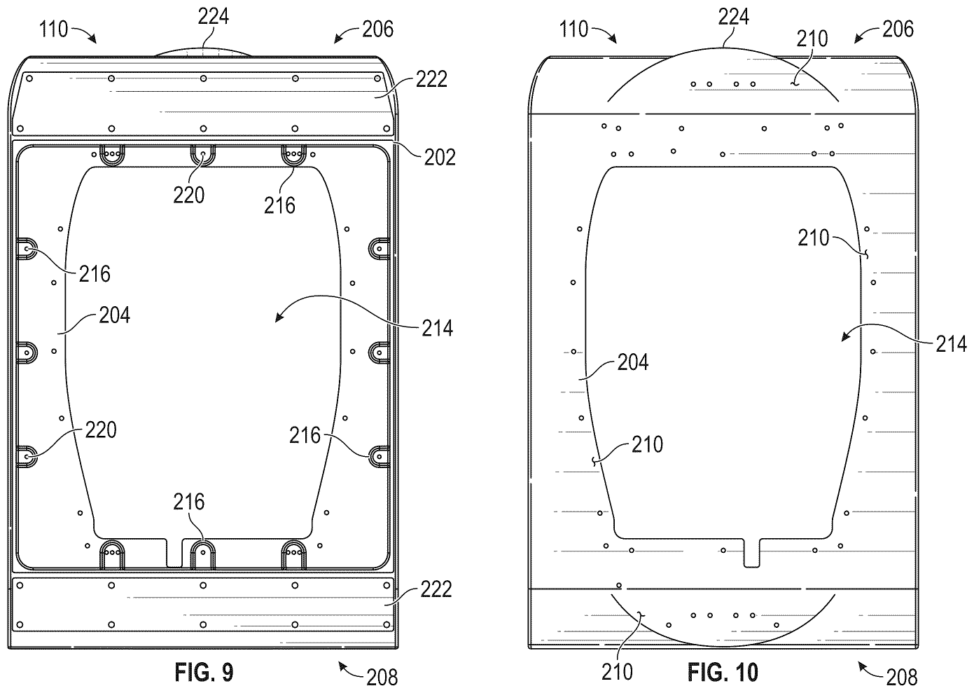

Referring to FIG. 7 and FIG. 9, the upper section 202, component cavity 212, and landings 216 are appropriately shaped, sized, and otherwise configured to receive and hold the antenna 108 in the desired position and orientation. The component cavity 212 is positioned in the upper section 202, such that the antenna 108 can be installed from the top side of the carrier housing 110. In accordance with the illustrated embodiment, the upper section 202 is configured to surround, encircle, or enclose the perimeter edge 122 of the antenna 108 after installation, and the carrier housing 110 holds the antenna 108 in place such that the major surface 120 of the antenna 108 remains substantially or completely exposed (see FIG. 2).

Referring also to FIG. 6, in accordance with the disclosed embodiment, the carrier housing 110 includes a plurality of landings 216 that are mapped to the mounting locations 126 of the antenna 108. Thus, the carrier housing 110 has twelve landings 216 that are arranged in a 1:1 relationship with the twelve mounting locations 126. Each landing 216 has a threaded fastener hole 220 (which may be a through hole in other embodiments) formed therein, which is located for indexing with a corresponding mounting hole of the antenna 108 and/or with a corresponding mounting hole of the retaining frame 119. When the antenna 108 is installed into the carrier housing 110, the bottom surfaces of the mounting locations 126 align with and rest upon the top surfaces of the landings 216.

In accordance with certain embodiments, the carrier housing 110 includes two cover plates 222. The cover plates 222 are used to cover cavities formed in the carrier housing 110 (the cavities are desirable to reduce the weight of the carrier housing 110, and the cover plates 222 are shaped and sized to seal the cavities while providing a desired aerodynamic profile). For the illustrated embodiment, the cover plates 222 also serve to hide fasteners that are used to secure the carrier housing 110 to the underlying mounting pedestal 112.

The retaining frame 119 (see FIG. 11) is used to secure the antenna 108 to the carrier housing 110, and to provide a smooth and aerodynamic exposed surface for the deployed system 102. FIGS. 2-4 depict the retaining frame 119 in its installed state, where it occupies space between the antenna 108 and the component cavity 212 of the carrier housing 110. The retaining frame 119 includes a pattern of cutouts 302 and tabs 304 defined around its inner perimeter (see FIG. 11). The depicted embodiment has twelve tabs 304, which correspond to the twelve mounting locations 126 of the antenna 108. Each tab 304 has a fastener hole 306 defined therein—the twelve fastener holes 306 are arranged such that they align with the twelve corresponding mounting holes of the antenna 108, and such that they align with the twelve corresponding fastener holes 220 of the carrier housing 110. Accordingly, threaded fasteners can be installed through the fastener holes 306 of the retaining frame 119, through the mounting holes of the antenna 108, and threaded into the fastener holes 220 of the carrier housing 110 to secure the antenna 108 in place. In this regard, the retaining frame 119 includes at least one connecting structure that overlaps an outer edge region of the antenna 108 to facilitate coupling to the antenna 108. When the antenna 108 is coupled to the carrier housing 110 in this manner, the carrier housing 110 surrounds, encircles, or encloses the perimeter edge 122 of the antenna 108.

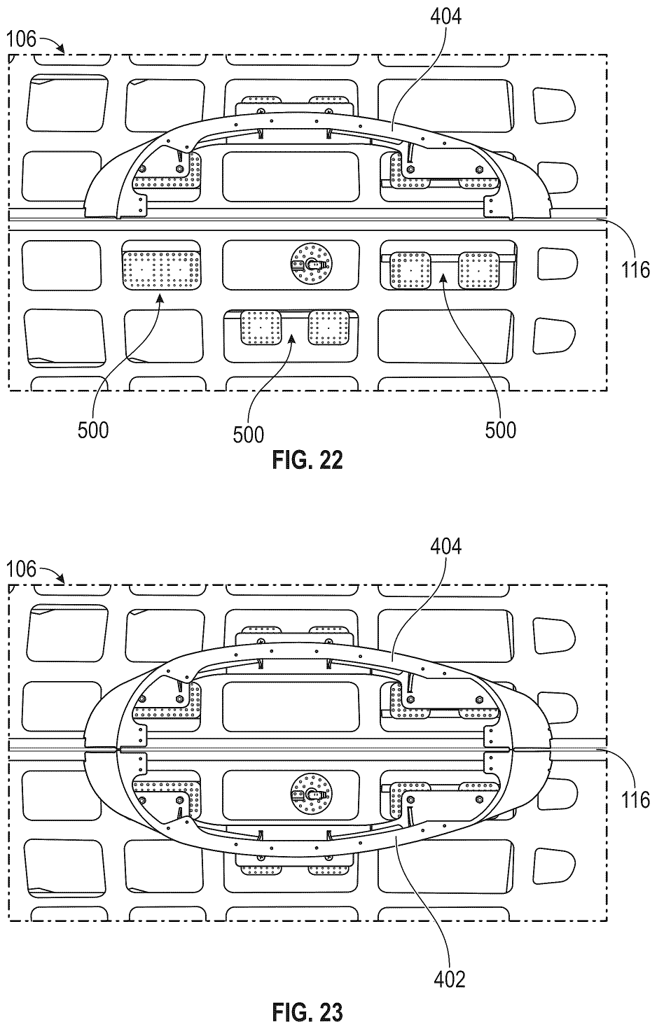

FIGS. 12-17 are different views of the mounting pedestal 112 by itself, and FIG. 18 is a side perspective view that shows the interior side of one half of the mounting pedestal 112. The mounting pedestal 112 serves as a “universal” component of the system 100 in that it need not be modified, altered, or redesigned to accommodate the particular item that is to be mounted. Instead, the carrier housing 110 is intended to be customized and configured as needed for compatibility with the particular physical characteristics of the component that is to be mounted, while remaining compatible with the mounting pedestal 112. The mounting pedestal 112 is manufactured from a strong and tough material such as steel, aluminum, a composite material, plastic, or the like. The mounting pedestal 112 can be fabricated as a one-piece unitary component, or as an assembly of any number of constituent parts. In accordance with the illustrated embodiment, the mounting pedestal 112 is implemented as an assembly that includes a left side component 402 and a right side component 404 that cooperates with the left side component 402. In practice, each half of the mounting pedestal 112 may be fabricated as a unitary one-piece component or as an assembly of multiple parts, e.g., a plurality of segments that are bolted, welded, or otherwise coupled together to form half of the mounting pedestal 112. Although not always required, the left and right side components 402, 404 are each implemented as an assembly of three main segments that are connected together. The segmented implementation is desirable for ease of manufacturing, assembly, and installation.

The illustrated embodiment of the mounting pedestal 112 (e.g., the left and right side components 402, 404 in combination) generally includes, without limitation: a top section 406; a bottom section 408; a forward region 410; an aft region 412; a rim 416; the passageway 118; an upper opening 424; a lower access opening 428; and an interior space 432. The mounting pedestal 112 is generally formed as a hollow shell having large openings at the top and bottom. In this regard, the left side component 402 represents the left sidewall, a portion of the front sidewall, and a portion of the rear sidewall of the mounting pedestal 112. Similarly, the right side component 404 represents the right sidewall, another portion of the front sidewall, and another portion of the rear sidewall of the mounting pedestal 112.

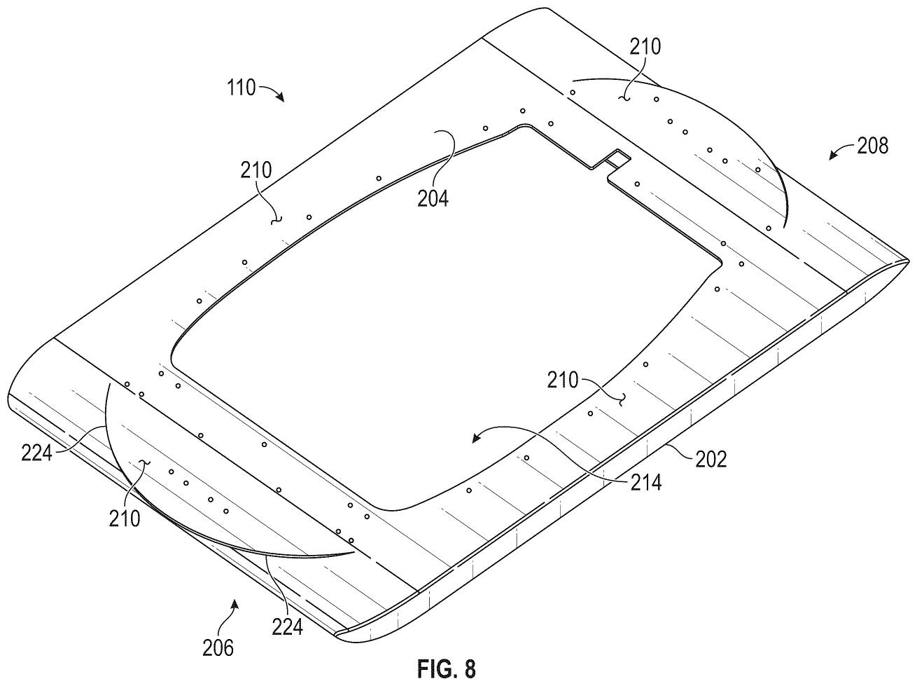

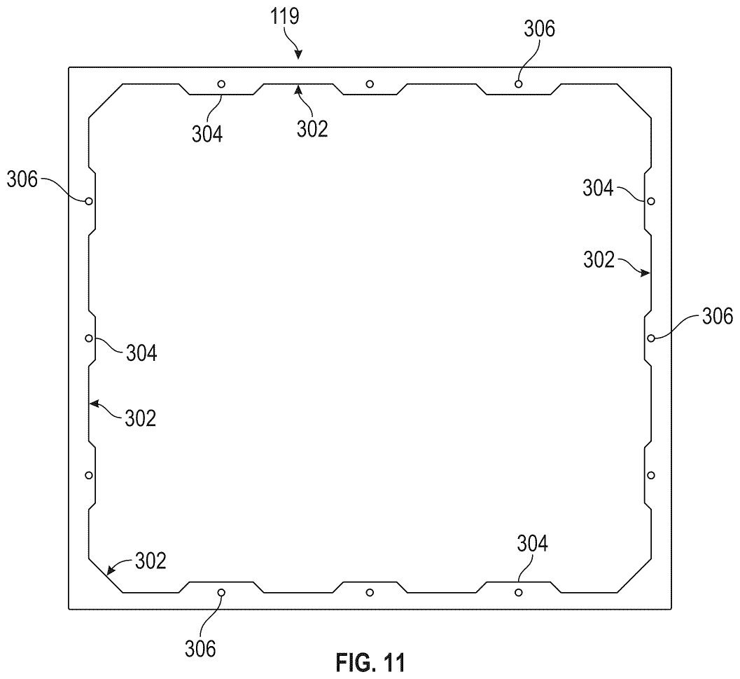

For the depicted embodiment, the rim 416 represents the uppermost region of the top section 406. The rim 416 includes or cooperates with a support platform 436 that is configured and arranged for coupling to the lower section 204 of the carrier housing 110. More specifically, the support platform 436 is shaped, sized, and arranged for compatible mating with the surface that is defined by the base region 210 of the carrier housing 110 (see FIG. 8 and FIG. 10, which show the bottom side of the carrier housing 110). The support platform 436 includes a number of mounting holes formed therein and arranged to accommodate a corresponding pattern of mounting holes formed in the base region 210 of the carrier housing 110. These cooperating mounting holes facilitate installation of the carrier housing 110 overlying the mounting pedestal 112.

The bottom section 408 of the mounting pedestal 112 is positioned opposite the top section 406 and opposite the rim 416. The bottom section 408 is suitably configured and arranged to facilitate secure coupling to an outer panel of the aircraft fuselage 106, e.g., the fuselage skin 104. To this end, the bottom section 408 includes or cooperates with a mounting platform 440 that also defines the bottom surface of the mounting pedestal 112. The mounting platform 440 is shaped, sized, and arranged in accordance with the physical characteristics of the fuselage skin 104 to facilitate secure attachment of the mounting pedestal 112 overlying the fuselage skin 104. Moreover, the left side component 402 of the mounting pedestal 112 includes or cooperates with a left mounting flange 444, and the right side component 404 of the mounting pedestal 112 includes or cooperates with a right mounting flange 446. Mounting holes 450 formed in the mounting flanges 444, 446 accommodate fasteners that are used to securely couple the mounting pedestal 112 to the aircraft fuselage 106.

The interior space 432 of the mounting pedestal 112 is generally defined by its interior surfaces and features. For the depicted embodiment, the interior space 432 is continuous with both the upper opening 424 and the lower access opening 428. In this regard, the interior space 432 is accessible from the top via the upper opening 424, and is accessible from the bottom via the lower access opening 428. In other words, the interior space 432 extends from the lower access opening 428 formed in the bottom section 408 to the upper opening 424 formed by the rim 416. With additional reference to FIGS. 7-10 (which show the carrier housing 110 by itself), at least a portion of the access opening 214 of the carrier housing 110 is continuous with the interior space 432 of the mounting pedestal 112 when the carrier housing 110 is coupled to the mounting pedestal 112. This arrangement facilitates installation of electrical cables and/or connectors of the antenna 108.

As mentioned above, the passageway 118 is configured and arranged to accommodate the dorsal structure 116 of the aircraft 100—the dorsal structure 116 protrudes above the fuselage skin 104 and extends in the longitudinal dimension of the aircraft 100. In accordance with the illustrated embodiment, the passageway 118 has an opening in the bottom section 408 of the mounting pedestal 112, and it extends upwards from the bottom section 408 toward the rim 416.

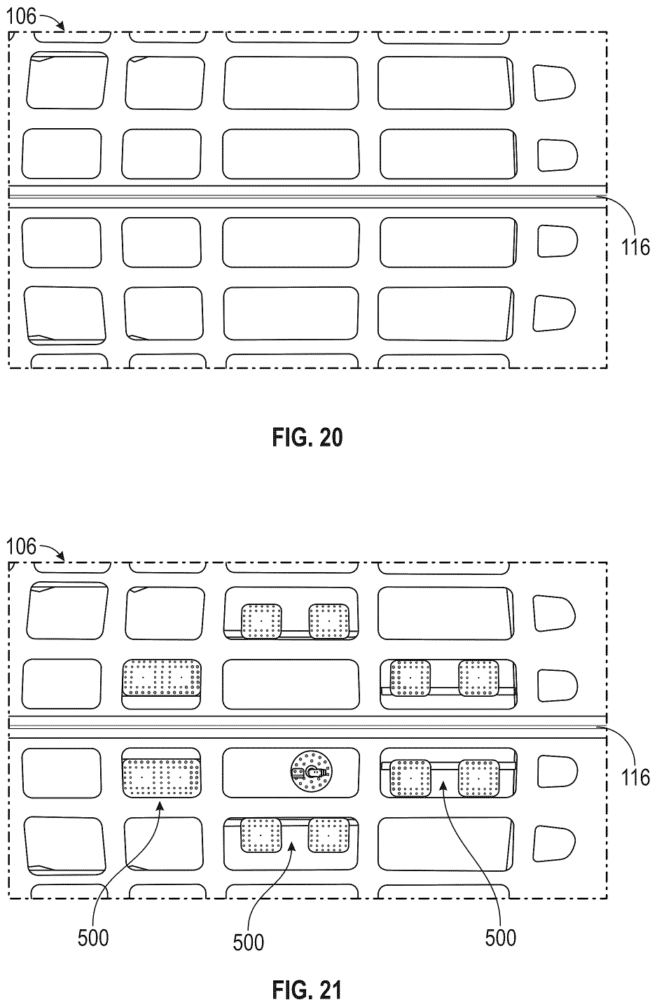

With additional reference to FIG. 2 and FIG. 23, the passageway 118 enables the mounting pedestal 112 to flank both sides of the dorsal structure 116 when the mounting pedestal 112 is coupled to the fuselage skin 104. For the embodiment described here, the left side component 402 of the mounting pedestal 112 is configured to be installed overlying the fuselage skin 104 adjacent to, and left of, the dorsal structure 116. Similarly, the right side component 404 is configured to be installed overlying the fuselage skin 104 adjacent to, and right of, the dorsal structure 116. As shown in FIG. 17, the passageway 118 may include or be defined by a vertical slot 454 and a flange cutout 458 that communicates with the vertical slot 454. The width of the vertical slot 454 accommodates the width of the dorsal structure 116. The height of the vertical slot 454 accommodates the height of the dorsal structure 116. In certain embodiments, the height of the vertical slot 454 is oversized such that the mounting pedestal 112 is compatible with different airframes (which may utilize dorsal structures 116 having different heights). A filler plate or plug can be installed to fill in any gap that might remain due to an oversized vertical slot 454. Similarly, the width of the vertical slot 454 may be oversized to accommodate dorsal structures 116 having different widths.

In accordance with exemplary embodiments, the carrier housing 110 and the mounting pedestal 112 cooperate to form an aerodynamic fairing for the antenna 108. To this end, the outer shape and contour of the mounting pedestal 112 can be designed and fabricated in an appropriate manner to improve aerodynamics. In addition, the forward region 410 of the mounting pedestal 112 can be designed and fabricated to provide impact protection (e.g., bird strike protection). Similarly, the outer shape and contour of the carrier housing 110 can be designed and fabricated in an appropriate manner to improve aerodynamics, and the forward region 206 of the carrier housing 110 can also be designed and fabricated to provide impact protection (e.g., bird strike protection).

The mounting pedestal 112 and the carrier housing 110 are cooperatively configured such that they form a smooth and substantially continuous transition at their respective front areas. In this regard, the forward region 410 of the mounting pedestal has a pedestal side profile that rises from a front area of the forward region 410 to a rear area of the forward region 410. This aerodynamic upwardly sloped shape of the mounting pedestal 112 is apparent in FIGS. 2, 5, 12, and 13. Similarly, the forward region 206 of the carrier housing 110 has a carrier side profile that rises from a front area of the forward region 206 to a rear area of the forward region 206. This aerodynamic upwardly sloped shape of the carrier housing 110 is best shown in FIG. 5. Notably, the side profile of the mounting pedestal 112 transitions into the side profile of the carrier housing 110 (see, for example, FIGS. 2, 4, and 5).

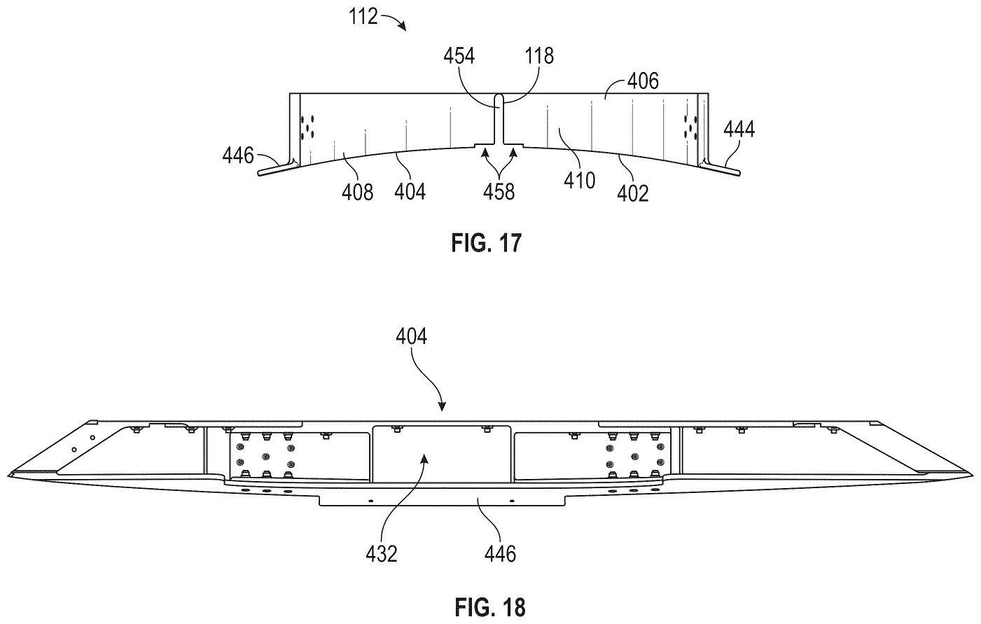

Moreover, the rim 416 of the mounting pedestal 112 includes a curved edge 462 that is defined at the forward region 410 (see FIG. 12 and FIG. 15). The curved edge 462 is outwardly curved in the forward direction, and the outer surface of the forward region 410 is convex. Similarly, the base region 210 of the carrier housing 110 has a curved leading edge 224 that is shaped, sized, and arranged in accordance with the curved edge 462 of the mounting pedestal 112 (see FIGS. 7-10). The curved leading edge 224 is outwardly curved in the forward direction and it is otherwise shaped, sized, and configured such that the curved edge 462 of the rim 416 aligns with the curved leading edge 224 when the carrier housing 110 is coupled to the mounting pedestal 112. The alignment and mating of these curved features is apparent in FIGS. 2, 4, and 5.

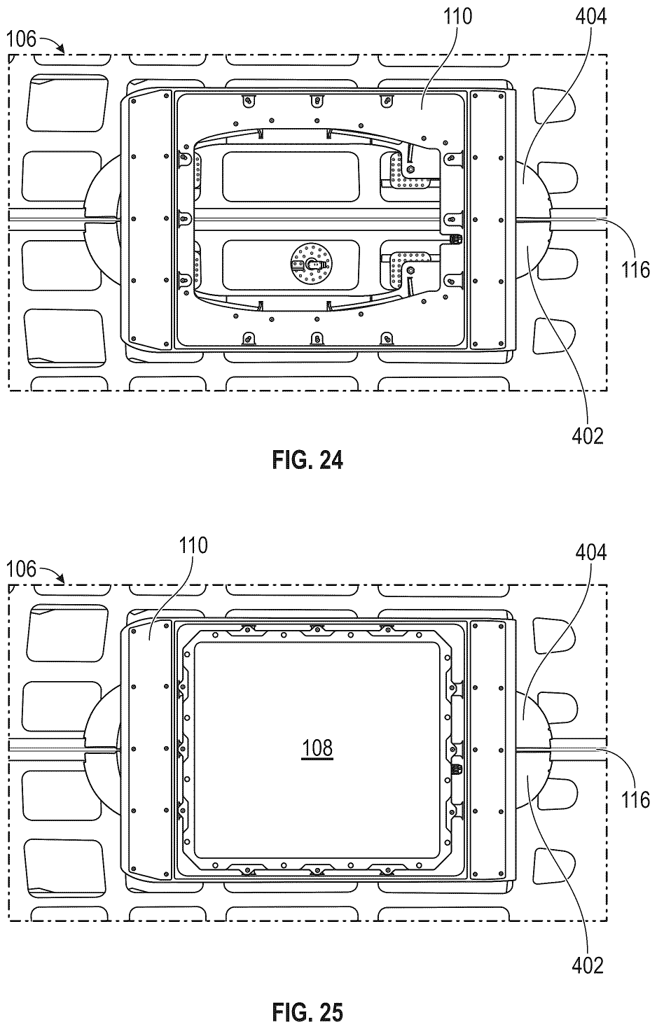

FIG. 19 is a perspective view that shows an exemplary arrangement of components and features (for mounting, installation, and structural support) that reside underneath the fuselage skin 104 of the host aircraft 100. FIG. 19 shows only a small section of the fuselage 106, along with various components, features, and structures utilized for installation of the mounting pedestal 112 and, in turn, the carrier housing 110 and the antenna 108 (which are hidden from view in FIG. 19 because they are located on the exterior side of the fuselage skin 104). The supporting and mounting elements are configured, positioned, and installed in an appropriate manner to accommodate attachment of the mounting pedestal 112 to an outer panel of the fuselage 106. The supporting and mounting elements are further configured, positioned, and arranged to structurally support the other components of the system 102 when the system 102 is deployed on the aircraft 100. FIG. 19 is an interior view that depicts an exemplary implementation of an installation arrangement 500 that can be utilized for mounting, installation, and structural support.

FIG. 19 corresponds to a viewpoint from inside of the fuselage 106, looking upwards at the concave interior side 502 of the fuselage skin 104 (the opposing exterior side of the fuselage skin 104 is hidden from view in FIG. 19). FIG. 19 shows a number of upwardly curved frames 506 that form part of the fuselage 106. The installation arrangement 500 is designed, configured, and implemented in an appropriate manner that contemplates existing structure and components of the fuselage 106, e.g., frames, stringers, skin, intercostals, brackets, and conduits. In this regard, the installation arrangement 500 represents a supplemental or reinforcing assembly of components that can be joined with existing elements of the fuselage 106 to provide additional structural integrity and robustness. As depicted in FIG. 19, at least some elements of the installation arrangement 500 can be coupled to the interior side 502 of the fuselage skin 104. The various elements of the installation arrangement 500 are positioned for accurate correspondence with respective overlying features of the system 102 (e.g., mounting fixtures, support structures, mounting holes of the mounting pedestal 112, electrical connectors or cables associated with the antenna 108).

An embodiment of the installation arrangement 500 may include any of the following components, without limitation: intercostal supports; beams; cross frames; doublers; fastener plates; brackets. The illustrated embodiment utilizes intercostal supports 510 arranged longitudinally. Although not separately labeled, any number of doublers can be utilized to provide structural support at designated areas underlying the fuselage skin 104. Any number of fastener plates can be utilized to accommodate mounting hardware for components that reside outside the fuselage 106. Any number of brackets (which may be realized in different shapes, sizes, and configurations) can be utilized to couple adjacent structural components together. For example, brackets can be used to couple an intercostal support 510 to a cross frame or a curved frame 506.

FIGS. 20-26 are schematic top views that illustrate the installation of an antenna and related mounting system configured in accordance with embodiments of the invention. For ease of description, these figures omit the fuselage skin so that components underlying the fuselage skin are clearly visible. In addition, these figures only show a small section of the aircraft fuselage 106.

FIG. 20 shows a section of the dorsal structure 116 as positioned atop the fuselage 106-FIG. 20 represents the state of the aircraft before installation of the system 102 begins. FIG. 21 depicts the state of the aircraft after placement of the installation arrangement 500 underlying the fuselage skin. A gain, the installation arrangement 500 represents the internal support structure that will be used to secure the mounting pedestal to the fuselage 106. Accordingly, FIG. 21 shows the installed locations of the internal support structures relative to the dorsal structure 116. FIG. 22 depicts the state of the aircraft after installation of the right side component 404 of the mounting pedestal, flanking one side of the dorsal structure 116. Although not separately shown in these figures, a suitably configured gasket and/or a layer of sealant material can be introduced between the bottom of the mounting pedestal and the outer surface of the fuselage skin. As shown in FIG. 22, certain components of the installation arrangement 500 are aligned with flanges and/or mounting holes of the right side component 404 to facilitate secure attachment of the right side component 404 to the fuselage 106. FIG. 23 depicts the state of the aircraft after installation of the left side component 402 of the mounting pedestal. As shown in FIG. 23, certain components of the installation arrangement 500 are aligned with flanges and/or mounting holes of the left side component 402 to facilitate secure attachment of the left side component 402 to the fuselage 106. FIG. 23 illustrates how the mounting pedestal accommodates the protruding portion of the dorsal structure 116.

FIG. 24 shows the state of the aircraft after the carrier housing 110 has been coupled to the mounting pedestal 112. Although not separately shown, a suitably configured gasket and/or a layer of sealant material can be introduced between the bottom of the carrier housing 110 and the rim of the mounting pedestal 112. FIG. 25 shows the state of the aircraft after the antenna 108 has been installed and secured by the carrier housing 110. After installation of the antenna 108 in this manner, the retaining frame 119 is introduced and secured around the perimeter of the antenna 108 as depicted in FIG. 26 (also shown in FIGS. 2-4). When installed, the retaining frame 119 secures the antenna 108 to the carrier housing 110.

FIGS. 1-26 relate to an embodiment of the system 102 that is compatible with antennas that are identical to or equivalently configured in accordance with the antenna 108 shown in FIG. 6. As mentioned above, a universal mounting pedestal 112 can be installed on an aircraft such that carrier housings that are compatible with different antenna configurations can be coupled to the universal mounting pedestal 112. Consequently, the carrier housing component can be swapped out as needed to mount the desired type of antenna (or other type of component) onto the universal mounting pedestal 112.

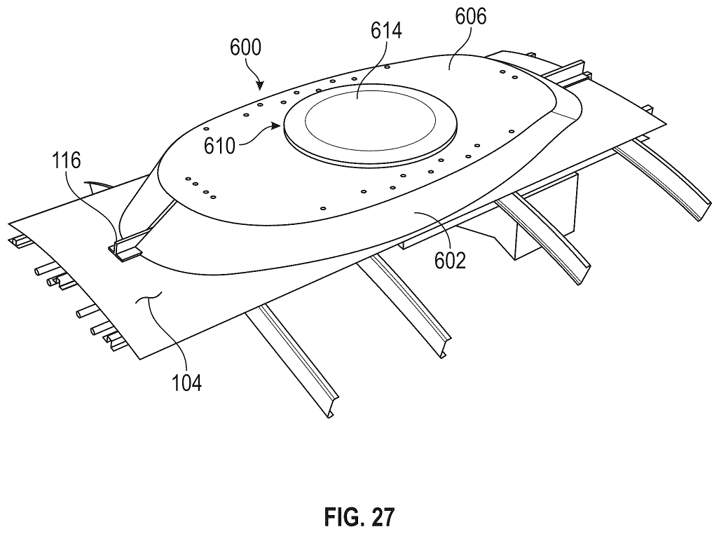

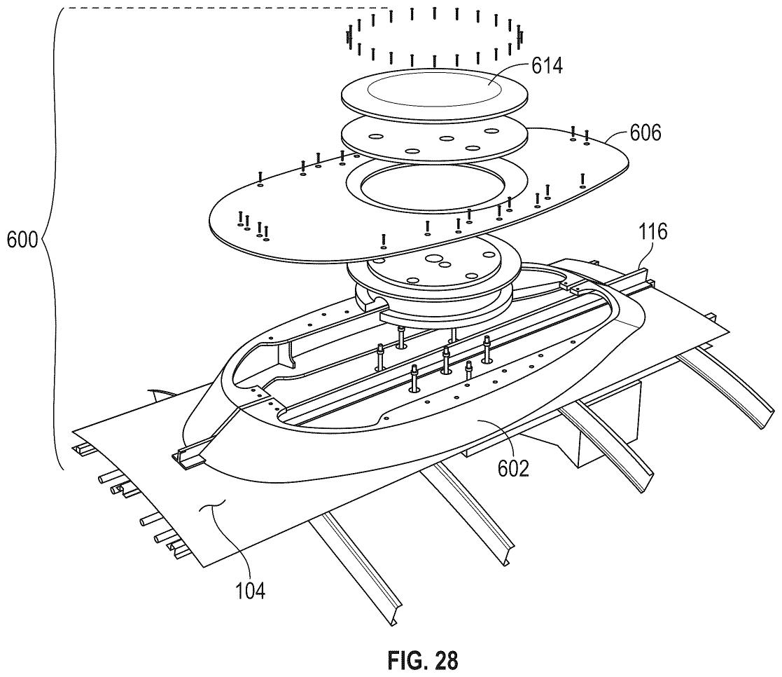

An alternate embodiment of a component mounting system 600 is depicted in FIG. 27 (a top-front perspective view) and FIG. 28 (an exploded perspective view). The illustrated embodiment of the system 600 includes a mounting pedestal 602 that can be identical, structurally equivalent, or physically similar to the mounting pedestal 112 described above. Indeed, the mounting pedestal 602 is suitably configured to be installed over the dorsal structure 116 that rises above the fuselage skin 104 in the manner described above. The system 600 utilizes a carrier housing 606 that is shaped, sized, and arranged differently than the carrier housing 110 utilized by the system 102. In this regard, the carrier housing 606 resembles a lid or a cover for the mounting pedestal 602, and the carrier housing 606 is designed and fabricated to be compatible with an antenna component 610 that has a round or disc-shaped upper region.

FIG. 27 shows the system 600 in its deployed state. In this state, an antenna cover 614 of the antenna component 610 is visible atop the carrier housing 606. The remaining elements of the antenna component 610 reside below the antenna cover 614 and are located within the interior space of the mounting pedestal 602. The interior space and other elements of the antenna component 610 are shown in FIG. 28. The system 600 is presented here to demonstrate how a universal or widely compatible mounting pedestal can accommodate different carrier housing configurations, which in turn are compatible with different antenna configurations. It should be appreciated that other form factors for the carrier housing can be designed and manufactured to suit the needs of the particular application, the dimensions of the component to be mounted, the mounting location, etc.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A system for mounting a component to an outer panel of a vehicle, the system comprising:
a carrier housing having an upper section configured to receive and hold the component, and having a lower section opposite the upper section; and
a mounting pedestal comprising:
a rim having a support platform configured and arranged for coupling to the lower section of the carrier housing;
a bottom section opposite the rim, the bottom section configured and arranged for coupling to the outer panel of the vehicle; and
a passageway having an opening in the bottom section, the passageway extending from the bottom section toward the rim, the passageway configured and arranged to accommodate a structural feature of the vehicle that extends from the outer panel of the vehicle.

2. The system of claim 1, wherein:
the upper section of the carrier housing is configured to surround a perimeter edge of the component; and
the carrier housing holds the component such that a major surface of the component is exposed.

3. The system of claim 1, wherein:
the outer panel has an exterior side and an opposing interior side;
the system further comprises an arrangement of supporting and mounting elements coupled to the interior side of the outer panel; and
the arrangement of supporting and mounting elements is configured to accommodate attachment of the mounting pedestal to the outer panel, and is further configured to structurally support the mounting pedestal when the mounting pedestal is attached to the outer panel.

4. The system of claim 1, wherein the passageway is configured and arranged to accommodate a dorsal structure of the vehicle.

5. The system of claim 4, wherein the mounting pedestal is configured and arranged to flank both sides of the dorsal structure of the vehicle.

6. The system of claim 1, wherein:
the mounting pedestal comprises a left side component and a right side component;
the left side component is configured to be installed overlying the outer panel adjacent to, and left of, the structural feature; and
the right side component is configured to be installed overlying the outer panel adjacent to, and right of, the structural feature.

7. The system of claim 1, wherein:
the mounting pedestal comprises a forward pedestal region having a pedestal side profile that rises from a front area of the forward pedestal region to a rear area of the forward pedestal region;
the lower section of the carrier housing comprises a forward carrier region having a carrier side profile that rises from a front area of the forward carrier region to a rear area of the forward carrier region; and
the pedestal side profile transitions to the carrier side profile.

8. The system of claim 1, wherein:
the mounting pedestal comprises a forward pedestal region;
the rim comprises a curved edge defined at the forward pedestal region;
the lower section of the carrier housing comprises a base region having a curved leading edge; and
the curved edge of the rim aligns with the curved leading edge of the lower section when the carrier housing is coupled to the mounting pedestal.

9. The system of claim 1, wherein:
the lower section of the carrier housing has an access opening defined therein;
the mounting pedestal has an interior space defined therein, the interior space extending from a lower opening formed in the bottom section of the mounting pedestal to an upper opening formed by the rim of the mounting pedestal; and
at least a portion of the access opening is continuous with the interior space when the carrier housing is coupled to the mounting pedestal.

10. The system of claim 1, wherein the carrier housing and the mounting pedestal cooperate to form an aerodynamic fairing for the component.

11. A system configured to be mounted to an outer panel of a vehicle, the system comprising:
an antenna component;
a carrier housing coupled to the antenna component, the carrier housing having an upper section configured to receive and hold the antenna component, and having a lower section opposite the upper section; and
a mounting pedestal comprising:
a rim having a support platform configured and arranged for coupling to the lower section of the carrier housing;
a bottom section opposite the rim, the bottom section configured and arranged for coupling to the outer panel of the vehicle; and
a passageway having an opening in the bottom section, the passageway extending from the bottom section toward the rim, the passageway configured and arranged to accommodate a structural feature of the vehicle that extends from the outer panel of the vehicle.

12. The system of claim 11, wherein the antenna component is a flat panel satellite communication antenna.

13. The system of claim 11, wherein:
the outer panel has an exterior side and an opposing interior side;
the system further comprises an arrangement of supporting and mounting elements coupled to the interior side of the outer panel; and
the arrangement of supporting and mounting elements is configured to accommodate attachment of the mounting pedestal to the outer panel, and is further configured to structurally support the mounting pedestal when the mounting pedestal is attached to the outer panel.

14. The system of claim 11, wherein the mounting pedestal is configured and arranged to flank both sides of a dorsal structure of the vehicle when the mounting pedestal is attached to the outer panel.

15. The system of claim 14, wherein:
the mounting pedestal comprises a left side component and a right side component;
the left side component is configured to be installed overlying the outer panel adjacent to, and left of, the dorsal structure; and
the right side component is configured to be installed overlying the outer panel adjacent to, and right of, the dorsal structure.

16. The system of claim 11, wherein:
the mounting pedestal comprises a forward pedestal region;
the rim comprises a curved edge defined at the forward pedestal region;
the lower section of the carrier housing comprises a base region having a curved leading edge; and
the curved edge of the rim aligns with the curved leading edge of the lower section when the carrier housing is coupled to the mounting pedestal.

17. The system of claim 11, wherein:
the lower section of the carrier housing has an access opening defined therein;
the mounting pedestal has an interior space defined therein, the interior space extending from a lower opening formed in the bottom section of the mounting pedestal to an upper opening formed by the rim of the mounting pedestal; and
at least a portion of the access opening is continuous with the interior space when the carrier housing is coupled to the mounting pedestal.

18. The system of claim 1, wherein the carrier housing and the mounting pedestal cooperate to form an aerodynamic fairing for the antenna component.

19. A vehicle comprising the system of claim 10.

20. The vehicle of claim 19, wherein:
the vehicle is an aircraft;
the outer panel corresponds to a fuselage skin of the aircraft; and
the antenna component is a flat panel satellite communication antenna.
